(19) United States
(12) Patent Application Publication
(10) Pub. No.: US 2017/0169170 A1
(43) Pub. Date: Jun. 15, 2017

(54) METHODS AND SYSTEMS FOR LOCATION-BASED ACCESS TO CLINICAL INFORMATION

(71) Applicant: Yosko, Inc., Los Angeles, CA (US)

(72) Inventor: Javier A. Otin, Boston, MA (US)

(21) Appl. No.: 15/374,407

(22) Filed: Dec. 9, 2016

Related U.S. Application Data
(60) Provisional application No. 62/266,296, filed on Dec. 11, 2015.

(51) Int. Cl. G06F 19/00; H04L 29/06; G06F 21/62

(52) U.S. Cl. CPC G06F 19/322; G06F 21/6245; H04L 63/107; H04L 63/0428; H04L 67/42

(57) ABSTRACT

A medical data management environment includes a plurality of beacon devices, a back-end system, an electronic health record (EHR) database, and one or more mobile devices communicatively coupled to the back-end system and the EHR database. Each mobile device can include a location-based clinical information access (LBCIA) application configured to cause that mobile device to detect a beacon device in proximity, identify a respective beacon ID, and send a first request including the beacon ID for patient information of a associated with the beacon ID. The back-end system can identify patient information including a patient ID based on the beacon ID and send the patient information to the mobile device. The LBCIA application can send a second request to the EHR database for access to patient clinical information associated with the patient ID. In response, the mobile device can receive the clinical information for display to a respective user.

### RELATED APPLICATION

This application claims the benefit under 35 U.S.C. §119(e) of U.S. Provisional Application No. 62/266,296, entitled “METHODS AND SYSTEMS FOR LOCATION-BASED ACCESS TO CLINICAL INFORMATION” and filed Dec. 11, 2015, which is incorporated herein by reference in its entirety.

### FIELD OF THE DISCLOSURE

The present application relates generally to systems and methods for location-based access to clinical information, and more particularly, to methods and systems for providing wireless and reliable access to electronic health records or other medical or health information associated with patients.

### BACKGROUND

The quality of healthcare services available to a given community or society can significantly impact the life quality of that community or society. In order to improve the quality of healthcare services provided, healthcare providers continue to adopt new technologies that reduce medical errors, improve efficiency of the provided services, or reduce the cost of such services.

### SUMMARY

According to one aspect, a system can include one or more computing devices (e.g., remote computer servers) and a location-based clinical information access (LBCIA) application executable on a client device. The one or more computing devices can include a database storing, for each patient of a plurality of patients, a respective pair of identifiers identifying that patient and a beacon device associated with that patient. When executed on a mobile device, an instance of the LBCIA application can cause the mobile device to detect a beacon device in proximity to the mobile device by receiving a beacon identifier (ID) from that beacon device. The instance of the LBCIA application can cause the mobile device to transmit, to the one or more computing devices, a first request for an identifier of a patient associated with the beacon device in proximity to the mobile device. The first request can include the beacon ID. The one or more computing devices can identify a patient ID mapped to the beacon ID in the database, responsive to the first request. The instance of the LBCIA application can cause the mobile device to receive, from the one or more computing devices, the patient ID responsive to the first request, and transmit, to an electronic health record (EHR) system, a second request for clinical health information of the patient associated with the beacon device in proximity to the mobile device. The second request can include the patient ID. The instance of the LBCIA application can cause the mobile device to receive, from the EHR system, responsive to the second request, the clinical health information of the patient associated with the beacon device in proximity to the mobile device, and display the clinical health information of the patient associated with the beacon device in proximity to the mobile device.

According to another aspect, a method of providing location-based access to medical data can include an instance of client application running on a mobile device detecting a beacon device in proximity to the mobile device by receiving a beacon identifier (ID) from that beacon device. The method can include the instance of the client application transmitting, to one or more computing devices, a first request for an identifier of a patient associated with the beacon device in proximity to the mobile device. The first request can include the beacon ID. The method can include the one or more computing devices identifying, responsive to the first request, a patient ID mapped to the beacon ID in a database maintained by the one or more computing devices. The method can include the instance of the client application receiving, from the one or more computing devices, the patient ID responsive to the first request, and transmitting, to an electronic health record (EHR) system, a second request for clinical health information of the patient associated with the beacon device in proximity to the mobile device. The second request can include the patient ID. The method can also include the instance of the client application receiving, from the EHR system, the clinical health information of the patient associated with the beacon device in proximity to the mobile device responsive to the second request, and causing the mobile device to display the clinical health information of the patient associated with the beacon device in proximity to the mobile device.

According to another aspect, a non-transitory computer-readable medium includes computer code instructions stored thereon. The computer code instructions, when executed by one or more processors, cause the one or more processors to detect a beacon device in proximity to a mobile device by receiving a beacon identifier (ID) from that beacon device. The one or more processors can transmit, to one or more computing devices, a first request for an identifier of a patient associated with the beacon device in proximity to the mobile device. The first request can include the beacon ID. The one or more computing devices can identify a patient ID mapped to the beacon ID in the database, responsive to the first request. The one or more processors can receive, from the one or more computing devices, the patient ID responsive to the first request, and transmit, to an electronic health record (EHR) system, a second request for clinical health information of the patient associated with the beacon device in proximity to the mobile device. The second request can include the patient ID. The one or more processors can receive, from the EHR system, the clinical health information of the patient associated with the beacon device in proximity to the mobile device responsive to the second request, and display the clinical health information of the patient associated with the beacon device in proximity to the mobile device.

In some embodiments, the beacon devices can include an iBeacon device, low frequency (LF) radio frequency identification (RFID) beacon device, high frequency (HF) beacon RFID device, ultra-high frequency (UHF) RFID beacon device, or a combination thereof. A beacon device can be configured to transmit an encrypted version of its beacon ID. The encrypted version of the beacon ID can be decrypted by the mobile device or by the back-end system.

While the systems, methods and computer-readable media described in this disclosure employ beacon devices, other tag devices (or tag technologies) such as near field communication (NFC) tags, radio frequency identification (RFID) tags, or other tag devices known in the art can be employed. For example, mobile devices, such as smartphones, tablets, laptops, etc., can include NFC readers (or NFC chips) integrated therein. Also, mobile devices can include RFID readers. In some embodiments, external NFC or RFID readers can be attached to a mobile device that has no internal NFC or RFID reading capabilities. The LBCIA can cause a mobile device on which it is running to receive an identifier (ID) from a NFC tag (or a RFID tag) associated with a patient. The LBCIA can send a first request, via the mobile device to the back-end system, for a patient identifier (patient ID) of a patient associated with the tag device (e.g., NFC tag or RFID tag) based on the ID received from the tag device.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2A is a diagram depicting a medical data management and access environment for location-based access of clinical data.

FIGS. 2B and 2C show diagrams illustrating embodiments of placing a beacon device in proximity to a respective patient.

FIG. 2D shows a diagram illustrating an embodiment of a user interface associated with a back-end system.

FIGS. 2E and 2F show diagrams of user interfaces illustrating an embodiment of updating beacon information maintained at the back-end system.

FIGS. 3A-3C show example snapshots of user interface of a location-based clinical information access (LBCIA) application.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for clinical decision support.

A. Computing and Network Environment

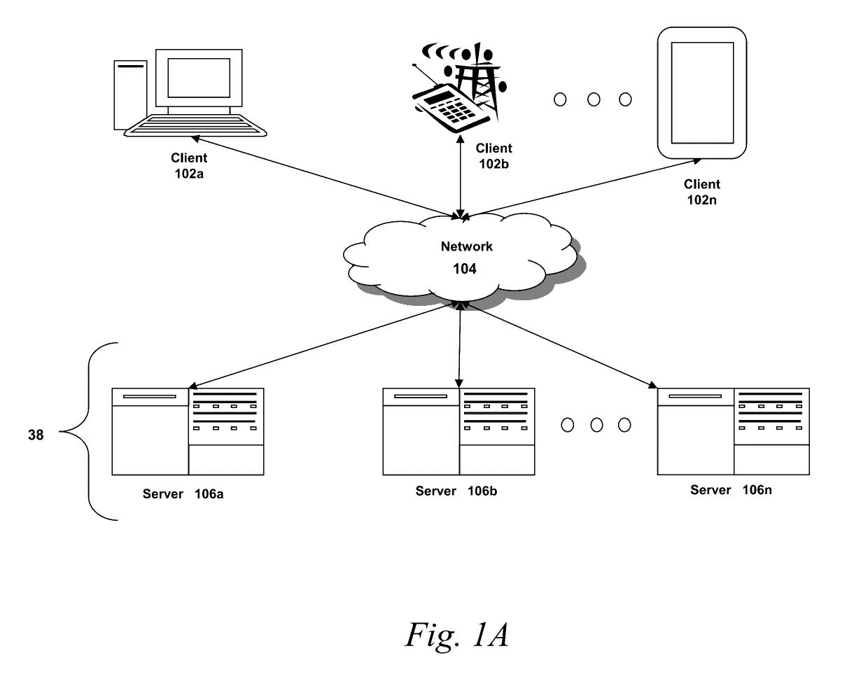

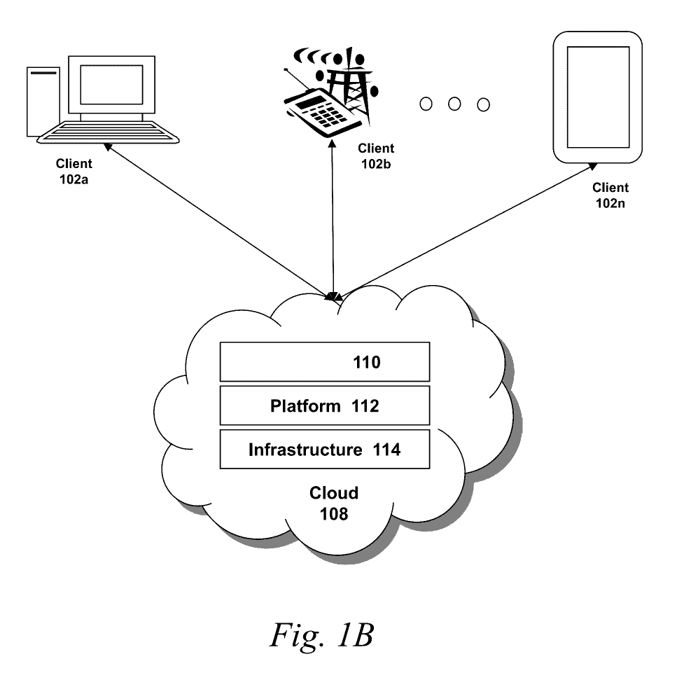

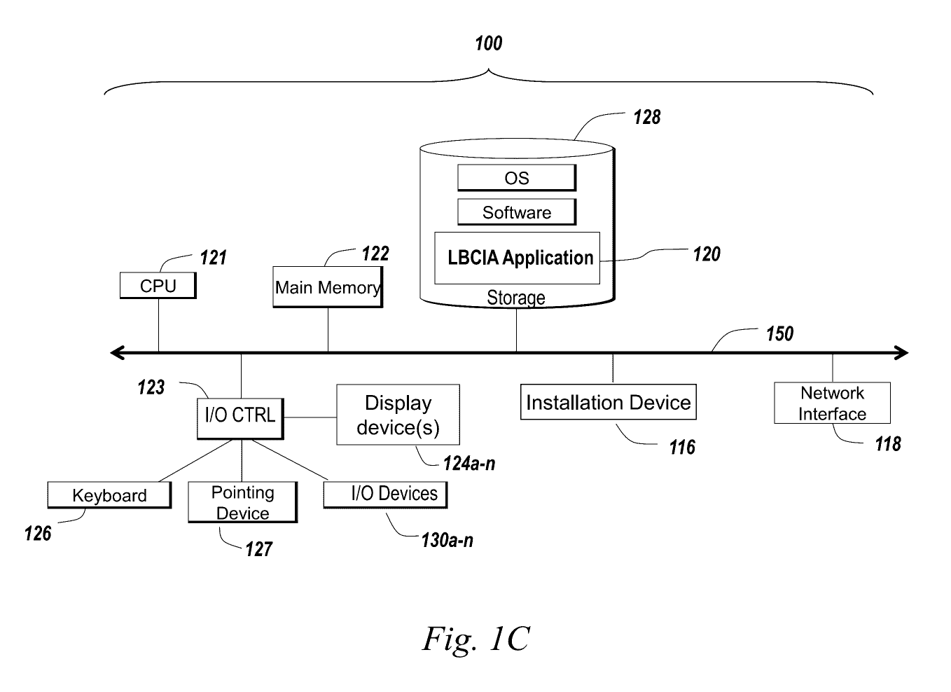

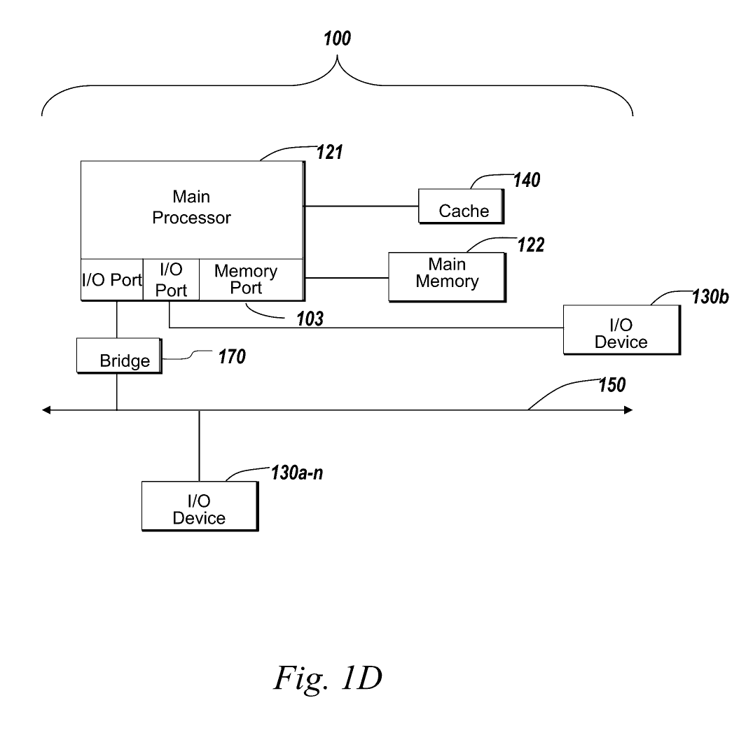

In addition to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 1G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, for example, Salesforce Sales Cloud, or Google Drive app. Clients 102 may also access SaaS resources through the client operating system, including, e.g., Windows file system for DROPB OX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a location-based clinical information access (LBCIA) application 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software for the location-based clinical information access (LBCIA) application 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Washington. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Systems and Methods for Providing Location-Based Access to Clinical Information

The present disclosure relates to systems and methods for providing location-based access to clinical information or other patient health or medical information. According to one aspect, a medical data management environment can include a plurality of beacon devices, a back-end system an electronic health record (EHR) database, and one or more mobile devices communicatively coupled to the back-end database and the EHR database. Each mobile device can include a respective instance of a location-based clinical information access (LBCIA) application. A LBCIA application can be viewed as a client application and can include one or more software modules, which when executed by a processor of the respective mobile device, can cause the mobile device to detect a beacon device, among the plurality of beacon devices, in proximity to the mobile device by receiving an identification (beacon ID) of the beacon device. The LBCIA application can send a first request, via the mobile device to the back-end system, for a patient identifier (patient ID) of a patient associated with the detected beacon device based on the beacon ID. The back-end system can be configured to store one or more data structures mapping beacon IDs to patient IDs of respective patients. Responsive to the first request, the back-end system can identify the patient ID associated with the beacon device and send the patient ID to the mobile device. Using the patient ID, the LBCIA application can send a second request, via the mobile device to the EHR database, for clinical information (or medical record information) associated with the patient identified with the patient ID. Using the patient ID, the EHR database can retrieve the clinical information associated with the patient identified with the patient ID from a storage memory and send the clinical information retrieved to the mobile device. The mobile device can then display the clinical information for a respective user.

The medical data management environment can help reduce medical errors due to wrongful identification of patients or patient medical records. The medical data management environment can also facilitate and speed up access of clinical data, by medical professional, while enforcing security and privacy of patient information.

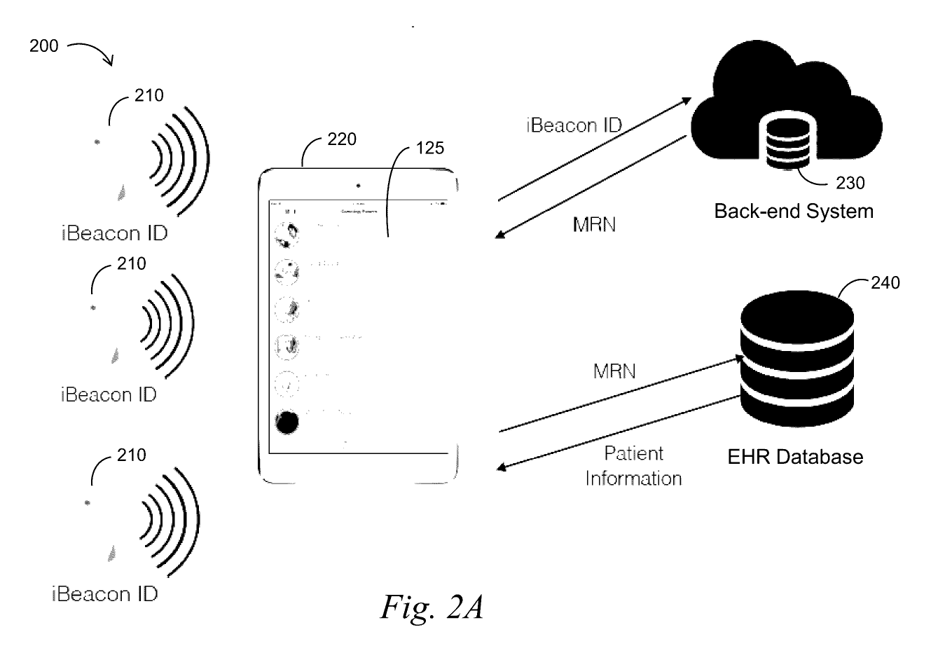

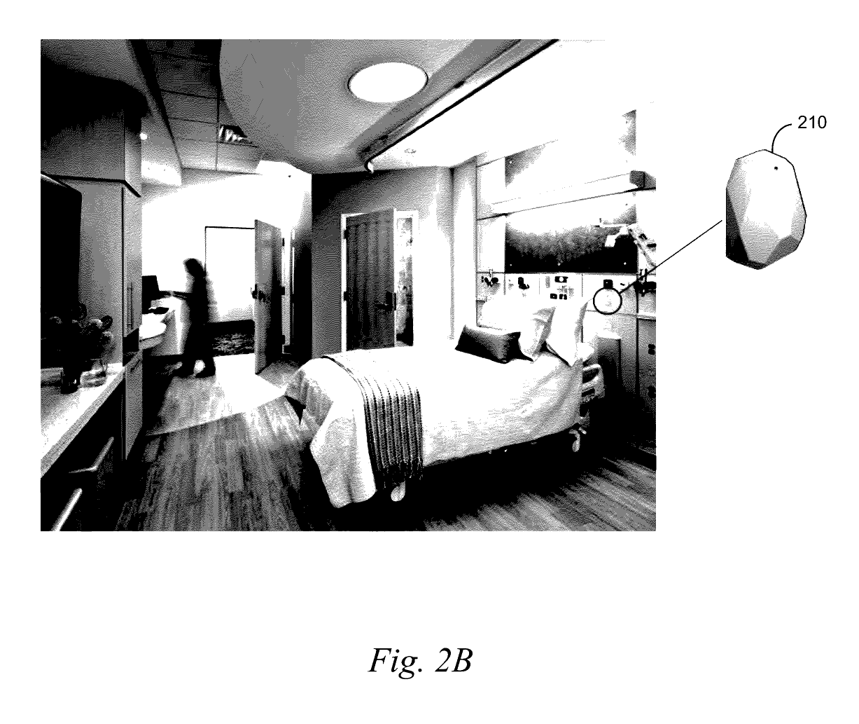

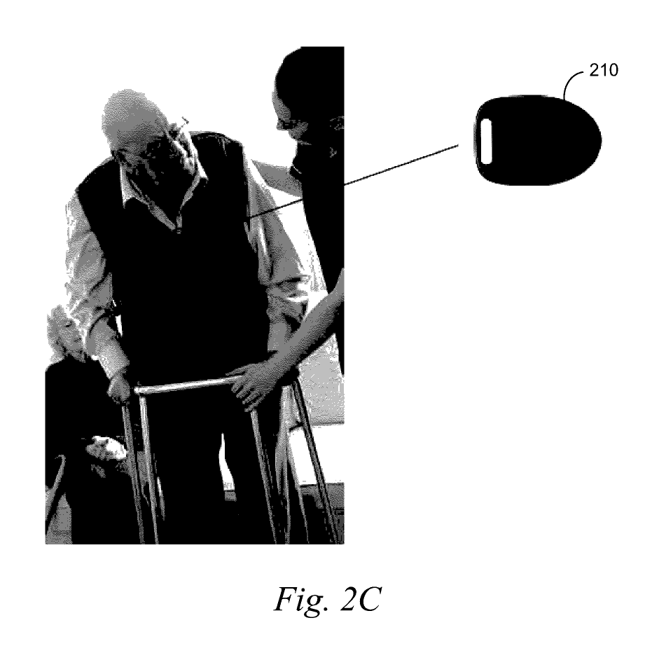

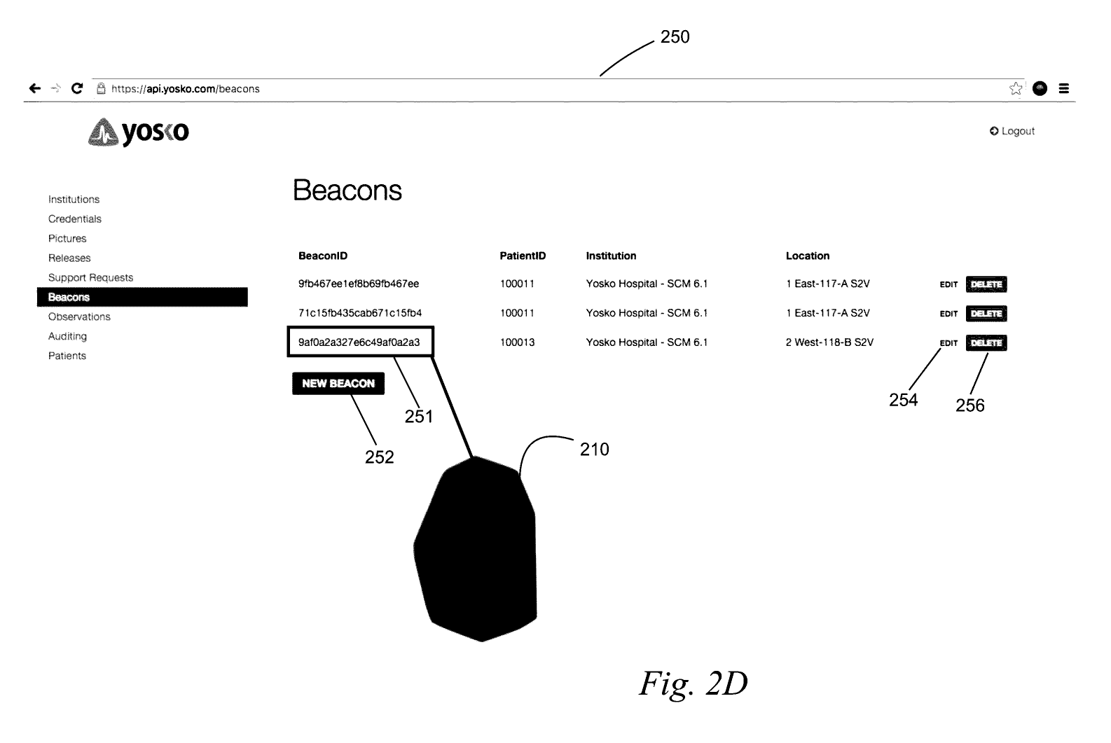

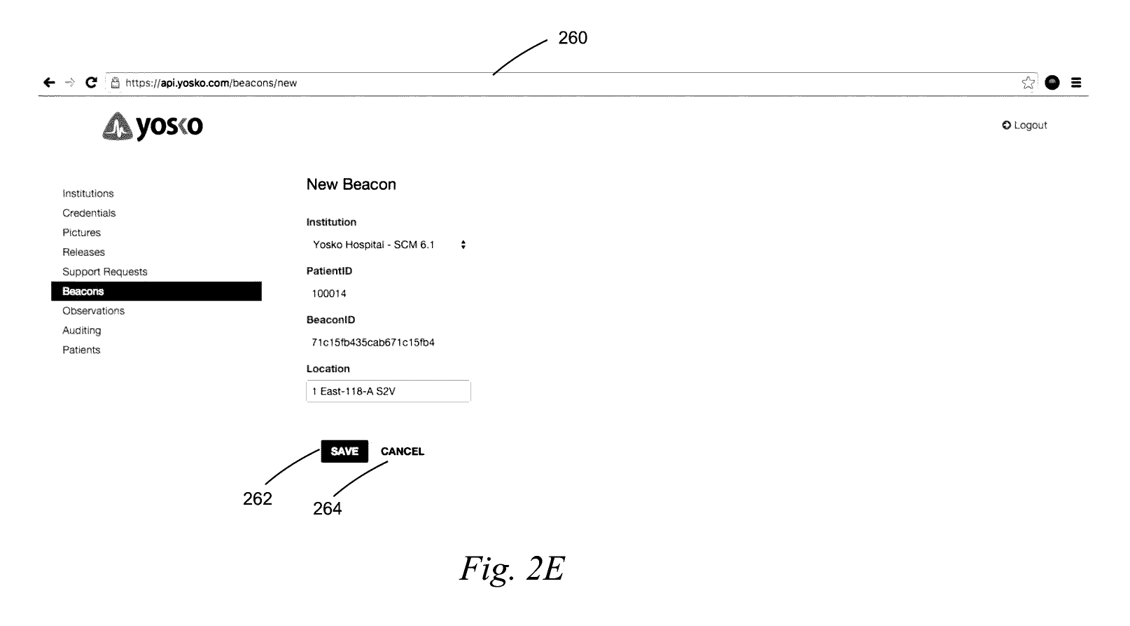

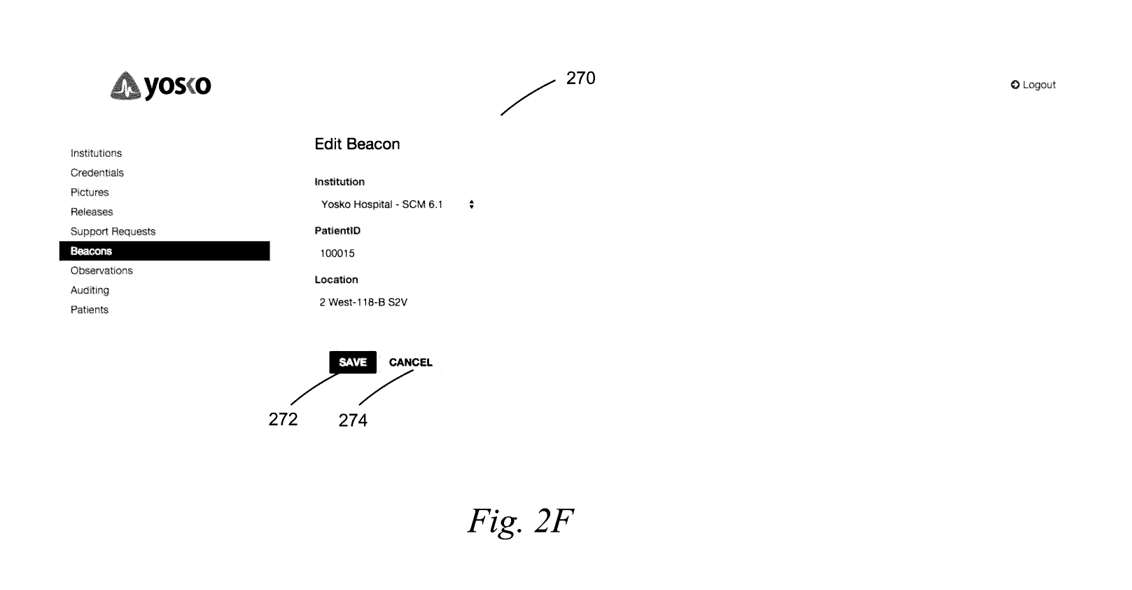

FIG. 2A is a diagram depicting a medical data management and access environment 200 for location-based access of clinical data. In brief overview, the medical data management and access environment 200 can include a plurality of beacon devices 210, a back-end system 230, an electronic health record (EHR) system 240, and a mobile device 220 communicatively coupled to the back-end system 230 and the EHR system 240. The mobile device 220 can include a location-based clinical information access (LBCIA) application 120 (shown in FIG. 1C) configured to access and display clinical information for patients associated with beacon devices 210 in proximity to the mobile device 220. The LBCIA application 120 can include a user interface 125 for displaying patient information responsive to detected beacon devices 210. The back-end system 230 can include a database storing, for each patient of a plurality of patients, data mapping the patient ID for that patient to a beacon ID of a beacon device assigned to (or associated with) that patient.

Each beacon device 210 is configured to transmit or broadcast signals at regular time intervals, such as every second or a fraction thereof, every few seconds, every minute, every few minutes, or the like. The signal transmitted by each beacon device 210 can include (or can be indicative of) a beacon identifier (ID) of that beacon device. The beacon ID can include a universal unique identifier (UUID). Each beacon device 210 may be configured to transmit an encrypted version of its beacon ID. Signals transmitted by a beacon device 210 can be received by a receiving device (such as the mobile device 220) that is in the proximity of that beacon device 210. The beacon devices 210 can include an iBeacon device, low frequency (LF) radio frequency identification (RFID) beacon device, high frequency (HF) RFID beacon device, ultra-high frequency (UHF) RFID beacon device, or a combination thereof. A beacon device, such as an iBeacon device, can employ BLUETOOTH™ low energy communication technology to transmit or broadcast information.

Each beacon device 210 can be assigned to a respective patient. Assigning a beacon device 210 to a given patient can include mapping, for instance in a database, the beacon ID of that beacon device 210 to patient information, such as a patient profile, of the given patient. Patient information mapped to a respective beacon ID can include a patient identifier (patient ID), patient name, patient photo, patient location, other patient information, or a combination thereof. A beacon device 210 can be assigned permanently or temporarily to a respective patient. For instance, a beacon device 210 can be assigned to a first patient during a first time period (e.g., while the first patient is hospitalized, under a specific treatment, or suffering from a specific condition) and assigned to a second patient during a second time period (e.g., while the second patient is hospitalized, under a specific treatment, or suffering from a specific condition).

Referring to FIGS. 2B and 2C, illustrated are embodiments of placing a beacon device 210 in proximity to a respective patient. A beacon device 210 assigned to a respective patient can be used to identify that patient. In the embodiment illustrated in FIG. 2B, the beacon device 210 can placed near the bed of an in-patient (such as a patient staying in a medical facility while under treatment). When in close proximity to the in-patient's bed, a mobile device 220 (such as a tablet, mobile phone or laptop associated with a medical professional) can detect the beacon device 210 placed near the in-patient's bed and use the respective beacon ID to identify the in-patient occupying the bed and retrieve the clinical information of that in-patient. The broadcasting (or transmission) range of the beacon device 210 depends on the transmission power of the beacon device 210. In some instances, the transmission power of the beacon device 210 can be adjusted, for example, by changing settings of the beacon device 210. The mobile device 220 can receive signals from a beacon device 220 once it is within the broadcasting range (e.g., within one or more centimeters or within one or more meters) of that beacon device 210.

In the embodiment illustrated in FIG. 2C, the beacon device 210 can be a wearable device or a device that can be attached to the clothes of the patient to whom the beacon device 210 is assigned. For example, the beacon device 210 can be part of bracelet, ring, neckless or other wearable item. In some examples, the beacon device 210 can be attached to clothes of the patient to whom it is assigned through a clip or other mechanism. In such examples, a mobile device 220 (such as a tablet, mobile phone or laptop of a medical professional) that is in close proximity (e.g., within few centimeters or within one or more meters) to the patient can detect the beacon device 210 on the patient and use its beacon ID to identify the patient and retrieve the patient's clinical information.

Referring again to FIG. 2A, the back-end system 230 may include one or more computer servers, a database, or a combination thereof. The back-end system 230 can store data indicative of patient information, such as the patient name, patient photo, patient ID (such as the medical record number or ID of the patient), patient location, a medical facility (such a hospital, medical lab, or other medical services facility) used by the patient, or a combination thereof. The patient ID can include a medical record number (MRN) or medical record ID of a medical record of the patient stored in the HER database 240. When a beacon device 210 is assigned to the patient, the back-end system 230 stores the beacon ID of that beacon device 210 in association with the patient's information. For example, the back-end system 230 can maintain one or more data structures (such as a table, linked list, tree or other data structure) mapping patient information to the beacon ID of the beacon device assigned to the patient.

A computing device (such as a computer device associated with an administrator of the back-end system 230 or a computer device associated with a medical service provider) can access the back-end system 230 via a communication network, such as network 104 (shown in FIG. 1A). Access to the back-end system 230 can be secure. The back-end system 230 can enforce data security measures such as authentication rules, authorization rules, permission rules, or a combination thereof. Different users of the back-end system 230 may have different access privileges. For instance, compared to an administrator of the back-end system 230, a medical professional user (or a computing device thereof) may have limited data access.

Referring to FIG. 2D, illustrated is an embodiment of a user interface 250 associated with the back-end system 230. The user interface 250 allows for fetching and managing data stored in the back-end system 230 based on various criteria, such as registered beacon devices, registered patients, registered institutions (such as hospitals and other medical service providers), patient pictures, or other criteria. As depicted in FIG. 2D, when a user (such as an administrator of the back-end system 230) selects to fetch data based on registered beacon devices 210, the user interface can display a list of beacon IDs 251. Each beacon ID, corresponding to a respective beacon device 210, is associated with a patient ID, an institution and a geographic location. The patient ID is indicative of the patient to whom the beacon device 210 is assigned. The patient ID can include a medical record number, social security number, identification card number, or other number assigned as an identifier of the respective patient. The institution can be indicative of a medical institution (or other medical or health service provider institution) serving the patient or associated with the beacon device 210. The geographic location can be indicative of the last recorded location of the patient or a room within the institution where the patient is treated.

The user interface 250 can include an add icon 252 for adding (or registering) new Beacon devices. For each beacon ID 251, the user interface 250 can include a respective edit icon 254 and a respective delete icon 256. The edit icon 254 allows for editing information associated with the respective beacon ID 251 (or the respective beacon device 210). The delete icon 256 allows for deleting information associated with the respective beacon ID 251 (or the respective beacon device 210).

FIG. 2E shows a user interface 260 for adding or registering a new beacon device 210. A computing device (such as a computer device associated with an administrator of the back-end system 230 or a computer device associated with a medical service provider) can display user interface 260 responsive to actuation of the add icon 252. The user interface 260 can provide a user with input entries for typing or selecting an institution, patient ID, beacon ID 251, geographic location or a combination thereof. Upon entering information for a new beacon device 210, the use can actuate a save icon 262 to save the information and therefore register the new beacon device 210, or actuate a cancel icon 264 to cancel the process. Actuating the cancel icon 264 can refresh the input entries by deleting any information entered by the user. In some embodiments, actuating the cancel icon 264 can cause display of the user interface 250.

FIG. 2F shows a user interface 270 for editing information associated with a beacon device 210. A computing device (such as a computer device associated with an administrator of the back-end system 230 or a computer device associated with a medical service provider) can display user interface 270 responsive to actuation of an edit icon 254 associated with a respective beacon ID 251. The user interface 270 can provide can include input entries for an institution, patient ID, geographic location or a combination thereof. When the user interface 270 is displayed, the input entries display editable data (such as institution name, patient ID and location) associated with the beacon ID 251. A user can edit one or more data items displayed in the input entries and actuate a save icon 272 to save the edited information. Otherwise, the user can actuate a cancel icon 274 of the user interface 270, in which case the edits are not saved to the back-end system.

In some embodiments, a health facility (such as a hospital, a health care center, a medical nursing home or the like) can be associated with a plurality of beacon devices 210. For instance, the health facility can own, rent, or be assigned the plurality of beacon devices. The health facility can assign the respective beacon devices to their patients. For example, when a patient checks in at the health facility, a beacon device 210 can be assigned to the patient. The beacon device 210 may be unassigned at checkout.

A computing device associated with the health facility (such as the mobile device 220, a desktop, or another computing device) can send a first request to the back-end system 230 to assign the beacon device 210 to the patient. The first request can include the beacon ID 251 of the beacon device 210, an identification of the patient (such as the patient name or patient ID), and an identification of the health facility (such as a name, an identification number, or a combination thereof). The first request may include an indication of a location of the computing device sending the request or handling the checking process. Responsive to the first request, the back-end system 230 may check based on the beacon ID and the identification of the health facility whether the beacon device 210 is associated with the health facility. If the back-end system 230 determines that the beacon device 210 is associated with the health facility, the back-end system 230 can map the beacon ID to the patient's information. For instance, the back-end system 230 can update information associated with the patient identified in the first request to add the beacon ID in association with the patient information (for example, as depicted in FIG. 2D). In some embodiments, assigning a beacon device 210 to a patient can be achieved using any combination of the user interfaces 250, 260, or 270. For example, using the edit icon 254 and the user interface 270, a user can insert a patient ID and/or location information associated with a given beacon ID 251.

During patient checkout, a computing device associated with the health facility can send a second request to the back-end system 230 to de-assign (or unassign) the beacon device 210 that is assigned to the patient. The second request can include the beacon ID of the beacon device 210, an identification of the health facility, and an indication that the second request relates to de-assigning the beacon device 210 identified in the second request. Responsive to the second request, the back-end system 230 may check whether the beacon device 210 identified in the second request is associated with the health facility identified in the same request. If the back-end system 230 determines that the beacon device 210 is associated with health facility, the back-end system 230 can de-assign the beacon device 210 by deleting the respective beacon ID mapped to the patient information. As a result, the patient information is no more mapped to the beacon ID of the beacon device 210. In some implementations, the checking of whether the beacon device is associated with the health facility (whether responsive to the first request or the second request) may be optional. In some embodiments, de-assigning a beacon device 210 to a patient can be achieved using any combination of the user interfaces 250, 260, or 270. For example, using the edit icon 254 and the user interface 270, a user can delete the patient ID and the location information associated with a given beacon ID 251.

Referring back to FIG. 2A, the electronic health record (EHR) database 240 can be a database storing patients health and medical information. The EHR database 240 can be configured to maintain a health record for each patient. A patient's health record can include information such as, a patient ID (such as health record number, a social security number, or an identification card number), a patient profile, patient clinical information, medications, allergies, vital signs, medical tests, or a combination thereof. A patient profile can include information indicative of the name, age (or date of birth), gender, marital status, ethnicity (or race), or occupation of the patient. The patient profile can include a photo of the patient. The patient's clinical information can include indications of present and previous medical conditions of the patient and previous diagnoses. The clinical information can include indications of previous patient's visits to a doctor's office or a medical facility (such as indications of date, location and/or medical doctor or practitioner for each visit), patient's reasons for the visits (such as patient's complaints), and the diagnosis made at each visit. The clinical information can include patient's complaints (such as a patient's inquiry performed by a nurse or other medical practitioner) with respect to a current visit. The medications information can include a list of medications currently consumed by the patient, a list of medications previously consumed by the patient or a combination thereof. In some implementations, the medication information can include indications of any medical devices used by the patient. The allergies information can include a list of allergies (such as drug allergies, food allergies, latex allergy, pollen energy or any other allergy) that the patient is suffering from. The vital signs information can include vital signs measurements taken during a previous or current visits of the patient to a doctor's office or a medical facility. The vital signs information can include indications of the date, location and measurement values associated with each set of vital signs measurements (such as body temperature, heart rate, pulse rate, blood pressure, respiratory rate and/or oxygen level in blood). In some implementations, the vital signs information can further include patient's weight measurements. The medical tests information can include indications of medical tests (such as blood tests, urine test, biopsies, medical imaging tests, mental health tests, hearing tests, visual tests, or any other medical tests) performed on the patient, the respective dates, the entities that requested the tests, the entities that performed the tests, the test results (or test status) or a combination thereof.

The EHR database 240 can be configured to be searchable using a patient ID or a patient name. In some implementations, the EHR database 240 can be configured to provide statistical data. For instance, the EHR database 240 can be configured to provide statistical data in response to a query using one or more patient attributes (such as an age group, gender group, ethnicity group, specific health condition, specific medication or a combination thereof). In such instances, the EHR database 240 can provide statistical data of patients sharing the attributes in the query.

The mobile device 220 can include a tablet, a mobile phone, a laptop, a smart watch, or any other portable device. The mobile device 220 can include a LBCIA application 120 and an antenna (such as a BLUETOOTH™ antenna) to detect beacon devices 210 in the vicinity of the mobile device 220. The LBCIA application 120 can cause the mobile device 220 to act as a “listener” configured to detect signals transmitted by beacon devices 210 in the vicinity of the mobile device 220. The LBCIA application 120, when executed by a processor of the mobile device 220, may activate the antenna of the mobile device 220 to detect nearby beacon devices 210. The antenna when activated can receive signals transmitted by beacon devices 210 in proximity. As a user (such as a medical professional) of the mobile device 220 moves in proximity to a patient, the mobile device 220 can detect and receive signals from the beacon device 210 of that patient. The LBCIA application 120 can obtain the beacon ID of the patient's beacon device 210 based on signals received, by the antenna, from the patient's beacon device 210. Obtaining the beacon ID may include decrypting information in the signal received from the beacon device 210 in cases where such information is encrypted.

Responsive to receiving the beacon ID, the LBCIA application 120 can send a request for patient identification information to the back-end system 230. Sending the request for patient identification information may include the mobile device 220 forwarding the beacon ID to the back-end system 230. Sending the request for patient identification information may including LBCIA application 120 generating the request and causing the mobile device 220 to send the request to the back-end system 230. The request can include the beacon ID of the detected beacon device 210, information indicative of the health facility associated with the mobile device 220 (or providing service to the patient), information indicative of the location of the mobile device 220, information identifying the mobile device 220 (or the user thereof), or a combination thereof. With regard to location information, the LBCIA application 120 may obtain such information from a global positioning system (GPS) application in the mobile device 220 or may prompt the user of the mobile device 220 to enter a specific location within the health facility (such as a specific room). The LBCIA application 120 may then cause the mobile device 220 to send the location information to the back-end system 230 within the request for patient identification information or separately. The mobile device 220 may send request for patient information over a secure tunnel to the back-end system 230.

Responsive to the request for patient identification, the back-end system 230 can parse the request and identify the beacon ID, the health facility, or a combination thereof based on information in the request. The back-end system 120 may identify the health facility associated with the request based on an identifier of the health facility or based on location information included in the request. The back-end system 230 may check the authenticity of the beacon ID received in the request for patient information. Checking the authenticity of the beacon ID can include checking whether the beacon ID is registered in the back-end system 230. Checking the authenticity of the beacon ID may include the back-end system 230 checking whether the beacon device 210 identified by the beacon ID is associated with the health facility identified in the request for patient information. Checking the authenticity of the beacon ID can help protect patient information and prevent access to such data by intruders or users that do not have permission to access the information of the patient. In some embodiments, checking the authenticity of the beacon ID may be optional. For instance, the back-end system 230 may be configured to simply check whether the beacon ID is mapped to a patient or not.

If the back-end system 230 determines that the beacon ID is authentic, the back-end system 230 can identify a patient mapped to the beacon ID. Identifying a patient may include identifying patient information (such a patient ID, patient name, patient photo or a combination thereof) mapped to the beacon ID received in the request for patient information. The back-end system 230 can then generate a response message and send the response message to the mobile device 220. The response message can include the patient ID (such as a medical record number, a social security number, an identity card number, patient credentials for accessing the EHR database 240, or a combination thereof), patient name, patient photo, the location of the beacon device associated with the beacon ID, the medical institution owning or managing the beacon device or serving the patient, or a combination thereof. The back-end system 230 may update patient location information based on location information received in the request for patient information.

Upon receiving the response message, the LBCIA application 120 may cause the mobile device 220 to send a request for patient clinical information to the EHR database 240. The LBCIA application 120 can generate the request for patient clinical information to include the patient ID, an indication of the type of request, an indication of requested patient clinical information, or a combination thereof. Using the patient ID, the EHR database 240 can identify the patient clinical information and generate a response message including the patient clinical information. The response message can include other patient information, such as patient name, patient age or date of birth, patient gender, patient photo, patient primary doctor, patient vital signs measurements, patient medical condition(s), patient complaints (e.g., recent signs that the patient is recently complaining from), patient previous or current medications, patient allergies, a list of medical content items (or medical documents) of the patient, or a combination thereof. The EHR database 240 can then send the response message to the mobile device 220.

In some embodiments, requests or response messages exchanged between the mobile device and the back-end system 230 or the EHR database 240 can be encrypted. For instance, generating a request for patient information or a patient clinical information request may include the LBCIA application 120 (or other application associated with the mobile device 220) encrypting the request before sending to the back-end system 230 or to the EHR database 240.

Upon receiving the response message from the EHR database 240, the LBCIA application 120 can display at least part of the patient information on a display of the mobile device 220. The LBCIA application 120 may display the patient name, patient photo, patient age, a portion of the patient clinical information, or a combination thereof.

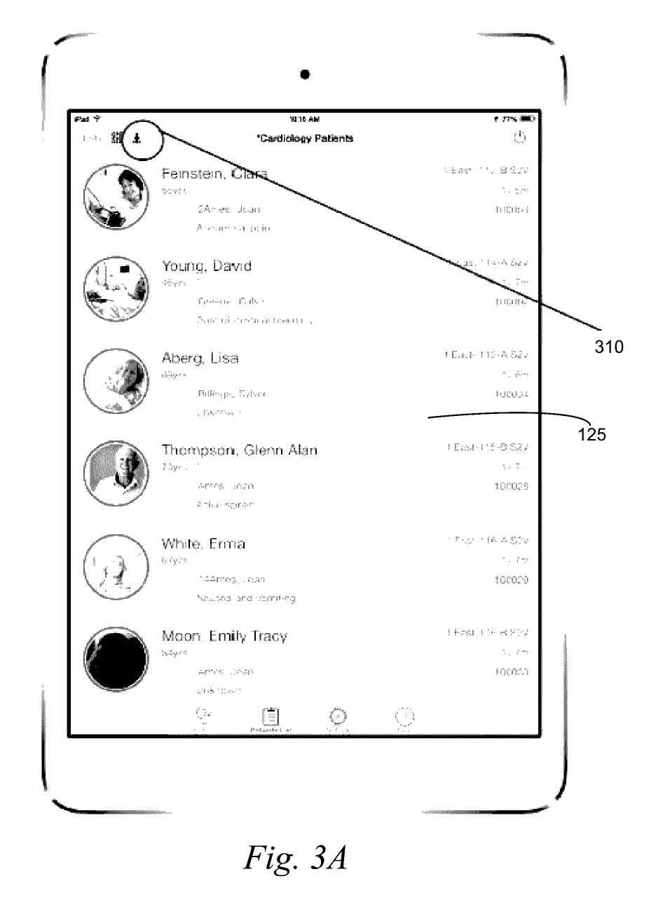

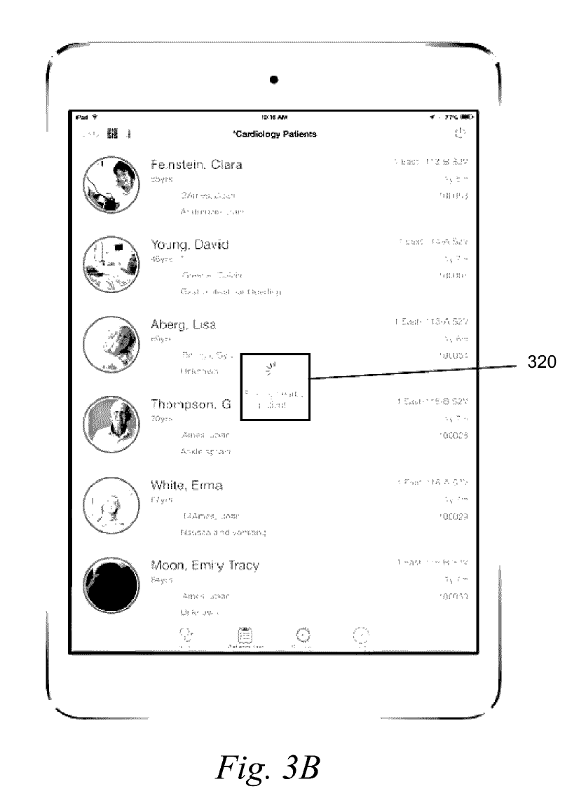

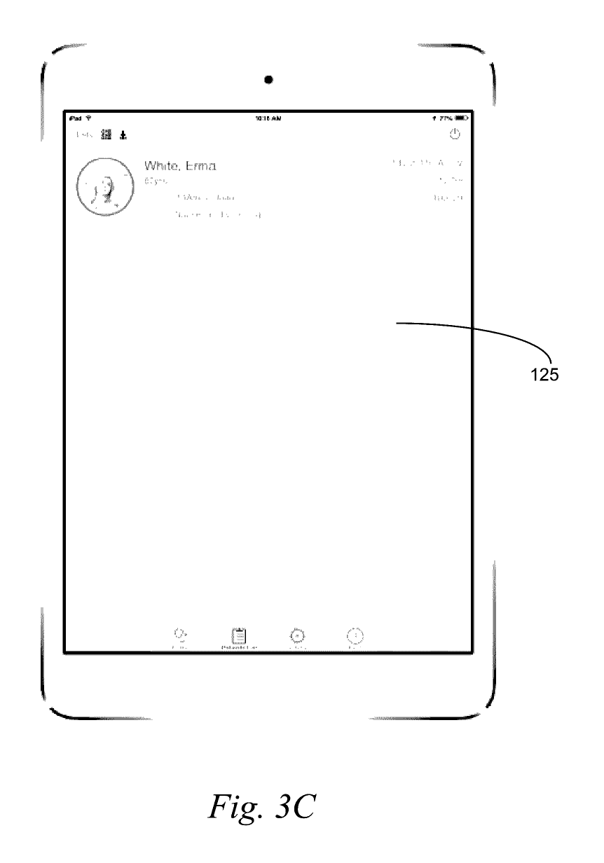

FIGS. 3A-3C show example snapshots of user interface 125 of the LBCIA application 120. FIG. 3A shows a snapshot of the user interface 125 where patient information for a list of patients is displayed. For each patient, the user interface 125 can show the patient name, patient age, patient gender, patient photo, patient medical condition, patient location, patient medical record number, the doctor (or medical professional) serving the patient, or a combination thereof. The user interface 125 can include a search icon 310 for searching for patients (or respective beacon devices 210) in proximity.

As illustrated in FIG. 3B, upon actuating the search icon 310, the LBCIA application 125 can cause the mobile device 220 (or an antenna thereof) to listen to any beacon devices 210 associated with any patients in proximity of the mobile device 220. As the mobile device 220 listens to detect any signals transmitted by nearby beacon devices 210, the user interface 125 can display a token 320 indicating that search for patients in proximity is underway. Upon, detecting a beacon device 210 in the vicinity of the mobile device 220 and obtaining clinical information for the corresponding patient from the EHR database 240, the user interface 125 can display patient information for any patient detected in proximity of the mobile device 220. As illustrated in FIG. 3C, the user interface 125 can show patient information (such as patient name, age or date of birth, gender, photo, medical condition, medical record number, etc.) for a patient associated with a nearby detected beacon device 210 is displayed. While FIG. 3C show that information for a single patient is displayed, the LBCIA 120 may detect multiple patients (or multiple beacon devices 210) in proximity at once.

The user interface 125 can include an actionable item to trigger or initiate a request for additional clinical information of the patient from the EHR system 240. For instance, upon a user of the mobile device 220 clicking (or touching in the case of a touch screen) on the patient's photo, patient's name, patient's ID, or a separate icon (not shown in FIGS. 3A-3C), the user interface 125 can display a list of documents or content items stored by the EHR system 240 as part of the patient's medical record. The content items (or documents) can include patient's clinical information indicative of medical (or lab) test results, medical imaging data, medical diagnosis, prescribed medications, medical surgeries, or a combination thereof. The user of the mobile device 220 can select one or more content items (or documents), and, in response, the LBCIA application 120 can send a request for such content item(s) (or document(s)) to the EHR system 240. The LBCIA application 120 (or the mobile device 220) can receive the list of content items (or documents) as part of the response to the request for patient's clinical information previously sent to the EHR system 240. The request for the content item(s) (or document(s)) can include the beacon ID (or patient ID) and an indication of the selected content item(S) (or document(s)). The EHR system 240 can retrieve the selected content item(s) and send them back to the mobile device 220. In response to receiving the content item(s), the LBCIA application 120 can cause the mobile device 220 to display the content item(s).

In some embodiments, the LBCIA application 120 may be configured to detect nearby beacon devices even when running in the background. In such embodiments, the LBCIA application 120 can request patient information from the back-end system 230 and patient clinical information from the EHR database 240. In response, the mobile device 220 can receive a notification indicative of basic information about the patient. When the user interacts with the notification, the mobile device 220 can display a user interface 125 showing information about the patient associated with the beacon device 210 (or tag device).

While the invention has been particularly shown and described with reference to specific embodiments, it should be understood by those skilled in the art that various changes in form and detail may be made therein without departing from the spirit and scope of the invention described in this disclosure. For example, tag devices such as NFC tags, RFID tags, or any other tag devices known in the art can be employed for providing IDs for use to request patient information from the back-end system 230 or patient clinical information from the EHR database 240.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A system for providing location-based access to medical data, the system comprising:
one or more computing devices including a database storing, for each patient of a plurality of patients, a respective pair of identifiers identifying that patient and a beacon device associated with that patient; and
a location-based clinical information access (LBCIA) application, when executed on a mobile device, an instance of the LBCIA application causes the mobile device to:
detect a beacon device in proximity to the mobile device by receiving a beacon identifier (ID) from that beacon device;
transmit, to the one or more computing devices, a first request, including the beacon ID, for an identifier of a patient associated with the beacon device in proximity to the mobile device, the one or more computing devices identifying a patient ID mapped to the beacon ID in the database, responsive to the first request;
receive, from the one or more computing devices, responsive to the first request, the patient ID;
transmit, to an electronic health record (EHR) system, a second request for clinical health information of the patient associated with the beacon device in proximity to the mobile device, the second request including the patient ID;
receive, from the EHR system, responsive to the second request, the clinical health information of the patient associated with the beacon device in proximity to the mobile device; and
display the clinical health information of the patient associated with the beacon device in proximity to the mobile device.

2. The system of claim 1 further comprising a plurality of beacon devices, each associated with a respective patient of the plurality of patients and having a respective beacon ID.

3. The system of claim 2, wherein the plurality of beacon devices include at least one of:
an iBeacon device;
a low frequency (LF) radio frequency identification (RFID) beacon device;
a high frequency (HF) beacon RFID device; or
an ultra-high frequency (UHF) RFID beacon device.

4. The system of claim 1 comprising the instance of the LBCIA application, when executed on a mobile device, causes the mobile device to:
receive an encrypted version of the beacon ID; and
decrypt the encrypted version of the beacon ID.

5. The system of claim 1, wherein, for each patient of the plurality of patients, the respective patient ID includes a medical record ID of a medical record associated with that patient.

6. The system of claim 1, wherein the clinical health information received from the EHR system includes at least one of:
patient name;
patient photograph;
patient age or date of birth; or
patient medical condition.

7. The system of claim 1, wherein the LBCIA application causes the mobile device to provide a user interface in display the clinical health information of the patient, the user interface including a search icon for initiating detection of beacon devices in proximity of the mobile device.

8. The system of claim 7, wherein the user interface provides an actionable item to initiate a request for additional clinical information of the patient from the EHR system.

9. A method of providing location-based access to medical data, the method comprising:
detecting, by an instance of client application running on a mobile device, a beacon device in proximity to the mobile device by receiving a beacon identifier (ID) from that beacon device;
transmitting, by the instance of client application, to one or more computing devices, a first request, including the beacon ID, for an identifier of a patient associated with the beacon device in proximity to the mobile device;
identifying, by the one or more computing devices, responsive to the first request, a patient ID mapped to the beacon ID in a database maintained by the one or more computing devices;
receiving, by the instance of client application, from the one or more computing devices, the patient ID responsive to the first request;
transmitting, by the instance of client application, to an electronic health record (EHR) system, a second request for clinical health information of the patient associated with the beacon device in proximity to the mobile device, the second request including the patient ID;
receiving, by the instance of client application, from the EHR system, the clinical health information of the patient associated with the beacon device in proximity to the mobile device responsive to the second request; and
causing, by the instance of client application, the mobile device to display the clinical health information of the patient associated with the beacon device in proximity to the mobile device.

10. The method of claim 9, wherein the plurality of patients are associated with a plurality of beacon devices, each beacon device of the plurality of beacon devices having a respective beacon ID.

11. The method of claim 10, wherein the plurality of beacon devices include at least one of:
an iBeacon device;
a low frequency (LF) radio frequency identification (RFID) beacon device;
a high frequency (HF) beacon RFID device; or
an ultra-high frequency (UHF) RFID beacon device.

12. The method of claim 9, wherein receiving the beacon ID includes:
receiving an encrypted version of the beacon ID; and
decrypting the encrypted version of the beacon ID.

13. The method of claim 9, wherein, for each patient of the plurality of patients, the respective patient ID includes a medical record ID of a medical record associated with that patient.

14. The method of claim 9, wherein the clinical health information received from the EHR system includes at least one of:
patient name;
patient photograph;
patient age or date of birth; or
patient medical condition.

15. The method of claim 9, wherein displaying the clinical health information includes providing a user interface for display by the mobile device, the user interface including a search icon for initiating detection of beacon devices in proximity to the mobile device.

16. The method of claim 15, wherein the user interface provides an actionable item to initiate a request for additional clinical information of the patient from the EHR system.

17. A non-transitory computer-readable medium including computer code instructions stored thereon, the computer code instructions when executed by one or more processors cause the one or more processors to:
detect a beacon device in proximity to the mobile device by receiving a beacon identifier (ID) from that beacon device;
transmit, to one or more computing devices, a first request, including the beacon ID, for an identifier of a patient associated with the beacon device in proximity to the mobile device, the one or more computing devices identifying a patient ID mapped to the beacon ID in the database, responsive to the first request;
identify, responsive to the first request, a patient ID mapped to the beacon ID in a database maintained by the one or more computing devices;
receive, from the one or more computing devices, the patient ID responsive to the first request;
transmit, to an electronic health record (EHR) system, a second request for clinical health information of the patient associated with the beacon device in proximity to the mobile device, the second request including the patient ID;
receive, from the EHR system, the clinical health information of the patient associated with the beacon device in proximity to the mobile device responsive to the second request; and
display the clinical health information of the patient associated with the beacon device in proximity to the mobile device.

18. The computer-readable medium of claim 17, wherein the clinical health information received from the EHR system includes at least one of:
patient name;
patient photograph;
patient age or date of birth; or
patient medical condition.

19. The computer-readable medium of claim 17, wherein displaying the clinical health information includes providing a user interface for display by the mobile device, the user interface including a search icon for initiating detection of beacon devices in proximity to the mobile device.

20. The computer-readable medium of claim 19, wherein the user interface provides an actionable item to initiate a request for additional clinical information of the patient from the EHR system.
